(19) United States
(12) Patent Application Publication
(10) Pub. No.: US 2016/0347622 A1
(43) Pub. Date: Dec. 1, 2016

(54) PROCESS FOR PRODUCING HYDROGEN CYANIDE USING FLOW STRAIGHTENER

(71) Applicant: INVISTA NORTH AMERICA S.A.R.L., Wilmington, DE (US)

(72) Inventors: John C. CATON, Yoakum, TX (US); Brent J. STAHLMAN, Victoria, TX (US); Rocky WANG, Port Lavaca, TX (US)

(73) Assignee: INVISTA NORTH AMERICA S.A R.L., Wilmington, DE (US)

(21) Appl. No.: 14/741,815

(22) PCT Filed: Dec. 12, 2013
(86) PCT No.: PCT/US2013/074648

§ 371 Date: Jun. 17, 2015

Related U.S. Application Data
(60) Provisional application No. 61/738,710, filed on Dec. 18, 2012.

(51) Int. Cl. C01C 3/02; B01F 5/06; B01J 8/02

(52) U.S. Cl. CPC C01C 3/0225; C01C 3/0216; B01J 8/0278; B01F 5/0618; B01J 2208/00849; B01J 2208/00938; B01F 2005/0627; B01F 2005/0636

(57) ABSTRACT

A flow straightener is disclosed for a hydrogen cyanide reaction process that maintains a substantially uniform velocity profile to provide a plug flow with reduced flow rotation within a mixing vessel. This results in improved performance and production of hydrogen cyanide.

### CROSS REFERENCE TO RELATED APPLICATION

This application claims priority to U.S. App. Ser. No. 61/738,740, filed Dec. 18, 2012, the entire contents and disclosures of which are incorporated herein.

### FIELD OF THE INVENTION

The present invention relates to a process for producing hydrogen cyanide and more particularly, to a flow straightener for aligning the flow of a ternary gas in a mixer.

### BACKGROUND OF THE INVENTION

Conventionally, hydrogen cyanide (“HCN”) is produced on an industrial scale according to either the Andrussow process or the BMA process. (See e.g., Uliman's Encyclopedia of Industrial Chemistry, Volume A8, Weinheim 1987, pages 161-163). For example, in the Andrussow process, HCN can be commercially produced by reacting ammonia with a methane-containing gas and an oxygen-containing gas at elevated temperatures in a reactor in the presence of a suitable catalyst (U.S. Pat. Nos. 1,934,838 and 6,596,251). Sulfur compounds and higher homologues of methane may have an effect on the parameters of oxidative ammonolysis of methane. See, e.g., Trusov, Effect of Sulfur Compounds and Higher Homologues of Methane on Hydrogen Cyanide Production by the Andrussow Method, Russian J. Applied Chemistry, 74:10 (2001), pp. 1693-1697). Unreacted ammonia is separated from HCN by contacting the reactor effluent gas stream with an aqueous solution of ammonium phosphate in an ammonia absorber. The separated ammonia is purified and concentrated for recycle to HCN conversion. HCN is recovered from the treated reactor effluent gas stream typically by absorption into water. The recovered HCN may be treated with further refining steps to produce purified HCN. Clean Development Mechanism Project Design Document Form (CDM PDD, Version 3), 2006, schematically explains the Andrussow HCN production process. Purified HCN can be used in hydrocyanation, such as hydrocyanation of an olefin-containing group, or such as hydrocyanation of 1,3-butadiene and pentenenitrile, which can be used in the manufacture of adiponitrile (“ADN”). In the BMA process, HCN is synthesized from methane and ammonia in the substantial absence of oxygen and in the presence of a platinum catalyst, resulting in the production of HCN, hydrogen, nitrogen, residual ammonia, and residual methane. (See e.g., Ullman's Encyclopedia of Industrial Chemistry, Volume A8, Weinheim 1987, pages 161-163). Commercial operators require process safety management to handle the hazardous properties of hydrogen cyanide. (See Maxwell et al. Assuring process safety in the transfer of hydrogen cyanide manufacturing technology, JHazMat 142 (2007), 677-684). Additionally, emissions of HCN production processes from production facilities may be subject to regulations, which may affect the economics of HCN manufacturing. (See Crump, Economic Impact Analysis For The Proposed Cyanide Manufacturing NESHAP, EPA, May 2000).

In producing HCN, the ammonia gas, methane-containing gas and oxygen-containing gas are mixed to form a ternary gas mixture that is fed to the reactor. Because the HCN process involves several reactive gases, the mixing of these reactive gases prior to being contacted with the catalyst may be beneficial. However, when carrying out the prior mixing of the reactive gases, the risks associated with the reactivity of the gases may become apparent. U.S. Pat. No. 2,803,522 discloses a mixer for the oxygen-containing gas and ammonia. U.S. Pat. No. 3,063,803 discloses a detachable mounted gas mixing chamber connected to the reactor. U.S. Pat. No. 3,215,495 discloses an internal baffle within the gas mixing chamber to mix the reactant gases.

U.S. Pat. No. 6,649,137 describes a conical reactor head for use in chemical processes or other systems. The reactor head is adapted to connect to a catalyst-containing barrel. The reactor may be coupled with a rotation vane to induce laminar flow at the inlet of the reactor to increase reactor efficiency and prolong catalyst life.

Thus, what is needed are improved mixing vessels that reduce undesirable rotation while mixing reactant gases that are suitable for HCN production.

### SUMMARY OF THE INVENTION

In a first embodiment of the present invention, there is provided a process for producing hydrogen cyanide, comprising introducing a methane-containing gas, an ammonia-containing gas, oxygen-containing gas and mixtures thereof into an elongated conduit to form a gas mixture, aligning the flow of the gas mixture using a flow straightener to form a ternary gas mixture, and contacting the ternary gas mixture with a catalyst in a catalyst bed to provide a reaction product comprising hydrogen cyanide. The ternary gas mixture may comprise at least 25 vol. % oxygen. In one aspect, the oxygen-containing gas comprises at least 80 vol. % oxygen or preferably pure oxygen. The flow straightener comprises one or more radial plates mounted to a center body, wherein the one or more radial plates extend lengthwise in the elongated conduit, and wherein the center body tapers outwardly from an upstream point to a downstream base. The center body may be a pyramid or cone. The downstream base of the center body is a circle, triangle, square, diamond, rectangle, pentagon, or hexagon. The one or more radial plates have a substantially smooth surface. The center body may be concentrically located within the elongated conduit. In one aspect, the flow straightener comprises stainless steel

Across the flow straightener, there is a substantially uniform velocity profile. In one aspect, the process produces a ternary gas mixture having a bed temperature variation from 15° C. to 25° C. across the catalyst bed. The ternary gas mixture has a coefficient of variation of less than 0.1 across the diameter of the catalyst bed. In one aspect, the methane-containing gas, the ammonia-containing gas, and the oxygen-containing gas are mixed in the elongated conduit, wherein pressure drop during mixing is less than 35 kPa. Mixing may be achieved by a plurality of static mixer elements. During mixing, the ternary gas mixture is substantially free of rotation due to the presence of the flow straightener.

Another embodiment of the present invention is directed to a reaction assembly for preparing hydrogen cyanide comprising a mixing vessel and reactor vessel comprising a reactor inlet that is operatively coupled to the outlet to receive the ternary gas mixture, wherein the reactor vessel comprises a catalyst bed containing a catalyst for producing a hydrogen cyanide stream. Mixing vessel produces a ternary gas mixture and comprises an elongated conduit. The elongated conduit includes an outlet located at a downstream end of the elongated conduit; an internal wall; a first static mixing zone comprising a first inlet port for introducing at least one reactant gas selected from the group consisting of a methane-containing gas, an ammonia-containing gas, an oxygen-containing gas, and mixtures thereof, into the mixing vessel and a first flow straightener positioned downstream of the first inlet port; and a second static mixing zone located downstream to the first static mixing zone and comprising a second inlet port for introducing an oxygen-containing gas, and a second flow straightener positioned downstream of the second inlet port. Each of the flow straighteners may comprise from one to ten radial plates. Each of the flow straightener may have a unibody assembly. The one or more radial plates may be connected to the internal wall. The one or more radial plates may be connected to an annular ring. The annular ring may be connected to the internal wall. The center body may be hollow. The center body may be a pyramid. The pyramid may have corners that meet at least one of the one or more radial plates. The downstream base of the center body may be a circle, triangle, square, diamond, rectangle, pentagon, or hexagon. The conical-shape body may taper at an angle from 5° to 65°. The center body may be concentrically located within the elongated conduit. The downstream base may have a maximum diameter that is from 0.1*x to 0.5*x, wherein x is the radial length of the one or more radial plates. The one or more radial plates may have a height that is from 0.05*y to 0.3*y, wherein y is the diameter of the conduit. The one or more radial plates may have a rounded upstream edge. The upstream point may be equilateral with the rounded upstream edge. The one or more radial plates may have a substantially smooth surface. The first static mixing zone may comprise at least one secondary flow straightener. The at least one secondary flow straightener of the first static mixing zone may comprise one or more radial plates. The first static mixing zone and second static mixing zone may each further comprise a plurality of static mixing elements. The plurality of static mixing element may comprise a plurality of tabs having an upstream face that is angled in the flow direction. The pressure drop in the mixing vessel may be less than 35 kPa. In some aspects, the first flow straightener comprises one or more radial plates mounted to a center body, wherein the one or more radial plates extend lengthwise in the elongated conduit, and wherein the center body tapers outwardly towards the internal wall from an upstream point to a downstream base.

In a third embodiment, there is provided a reaction assembly for preparing hydrogen cyanide comprising (a) a mixing vessel to produce a ternary gas mixture comprising an elongated conduit which includes: an outlet located at a downstream end of the elongated conduit; an internal wall; a first static mixing zone comprising a first inlet port for introducing into the mixing vessel at least one reactant gas selected from the group consisting of a methane-containing gas, an ammonia-containing gas, an oxygen-containing gas, and mixtures thereof and a first flow straightener positioned downstream of the first inlet; and a second static mixing zone located downstream to the first static mixing zone and comprising a second inlet port for introducing an oxygen-containing gas into the mixing vessel, and a second flow straightener positioned downstream of the second inlet; wherein the first and second flow straighteners each comprises one or more radial plates mounted to a center body, wherein the one or more radial plates extend lengthwise in the elongated conduit, and wherein the center body tapers outwardly towards the internal wall from an upstream point to a downstream base; and (b) a reactor vessel comprising a reactor inlet that is operatively coupled to the outlet to receive the ternary gas mixture, and a catalyst bed containing a catalyst for producing a hydrogen cyanide stream.

In a fourth embodiment, there is provided a process for producing hydrogen cyanide, comprising: introducing a methane-containing gas, an ammonia-containing gas, oxygen-containing gas and mixtures thereof into an elongated conduit to form a gas mixture; aligning the flow of the gas mixture using a flow straightener to form a ternary gas mixture, wherein the flow straightener comprises one or more radial plates mounted to a center body, wherein the one or more radial plates extend lengthwise in the elongated conduit, and wherein the center body tapers outwardly from an upstream point to a downstream base; and contacting the ternary gas mixture with a catalyst in a catalyst bed to provide a reaction product comprising hydrogen cyanide. The ternary gas mixture may maintain a bed temperature variation from 15° C. to 25° C. across the catalyst bed. The process may further comprise maintaining a substantially uniform velocity profile across the flow straightener. The ternary gas mixture may comprise at least 25 vol. % oxygen. The oxygen-containing gas may comprise at least 80 vol. % oxygen or pure oxygen. The pressure drop during mixing may be less than 35 kPa. The ternary gas mixture may have a coefficient of variation of less than 0.1 across the diameter of the catalyst bed. The mixing may be achieved by a plurality of static mixer elements. The ternary gas mixture may be substantially free of rotation. The center body may a pyramid. The downstream base of the center body may be a circle, triangle, square, diamond, rectangle, pentagon, or hexagon. The one or more radial plates may have a substantially smooth surface. The center body may be concentrically located within the elongated conduit. The flow straightener may comprise stainless steel.

In a fifth embodiment, there is provided a process for producing hydrogen cyanide, comprising: aligning the flow of methane-containing gas and an ammonia-containing gas introduced into an elongated conduit and mixing to form a binary mixture; aligning the flow of the binary mixture and an oxygen-maintaining gas into the elongated conduit and mixing to form a ternary gas mixture; and contacting the ternary gas mixture with a catalyst in a catalyst bed to provide a reaction product comprising hydrogen cyanide, wherein the flow straightener comprises one or more radial plates mounted to a center body, wherein the one or more radial plates extend lengthwise in the elongated conduit, and wherein the center body tapers outwardly from an upstream point to a downstream base. The ternary gas mixture may maintain a bed temperature variation from 15° C. to 25° C. across the catalyst bed. The process may further comprise maintaining a substantially uniform velocity profile across the flow straightener. The ternary gas mixture may comprise at least 25 vol. % oxygen. The pressure drop during mixing may be less than 35 kPa. The ternary gas mixture may have a coefficient of variation of less than 0.1 across the diameter of the catalyst bed. The mixing may be achieved by a plurality of static mixer elements. The ternary gas mixture may be substantially free of rotation. The center body may be a pyramid. The downstream base of the center body may be a circle, triangle, square, diamond, rectangle, pentagon, or hexagon. The one or more radial plates may have a substantially smooth surface. The center body may be concentrically located within the elongated conduit.

### BRIEF DESCRIPTION OF THE DRAWINGS

FIG. 1 is a simplified schematic flow diagram of an HCN synthesis system according to an embodiment of the presently claimed invention.

FIG. 2 is cross-sectional view of a mixing vessel according to an embodiment of the presently claimed invention.

FIGS. 3A and 3B are a flow straightener having a pyramidal-shaped center body according to an embodiment of the presently claimed invention.

FIGS. 4A and 4B are a flow straightener having a pyramidal conical-shaped center body according to an embodiment of the presently claimed invention.

FIG. 5 is an annular ring according to an embodiment of the presently claimed invention.

### DETAILED DESCRIPTION OF THE INVENTION

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, group of elements, components, and/or groups thereof.

Language such as “including,” “comprising,” “having,” “containing,” or “involving,” and variations thereof, is intended to be broad and encompass the subject matter listed thereafter, as well as equivalents, and additional subject matter not recited. Further, whenever a composition, a group of elements, process or method steps, or any other expression is preceded by the transitional phrase “comprising,” “including,” or “containing,” it is understood that it is also contemplated herein the same composition, group of elements, process or method steps or any other expression with transitional phrases “consisting essentially of,” “consisting of,” or “selected from the group of consisting of,” preceding the recitation of the composition, the group of elements, process or method steps or any other expression.

The corresponding structures, materials, acts, and equivalents of all means or step plus function elements in the claims, if applicable, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment(s) described herein was/were chosen and described in order to best explain the principles of the invention and the practical application, and to enable others of ordinary skill in the art to understand the invention for various embodiments with various modifications as are suited to the particular use contemplated. Accordingly, while the invention has been described in terms of embodiments, those of skill in the art will recognize that the invention can be practiced with modifications and in the spirit and scope of the appended claims.

Reference will now be made in detail to certain disclosed subject matter. While the disclosed subject matter will be described in conjunction with the enumerated claims, it will be understood that they are not intended to limit the disclosed subject matter to those claims. On the contrary, the disclosed subject matter is intended to cover all alternatives, modifications, and equivalents, which can be included within the scope of the presently disclosed subject matter as defined by the claims.

Hydrogen cyanide (“HCN”) is produced on an industrial scale according to either the Andrussow process or by the BMA process. In the Andrussow process, methane, ammonia and oxygen-containing raw materials are reacted at temperatures above 1000° C. in the presence of a catalyst to produce a crude hydrogen cyanide product comprising HCN, hydrogen, carbon monoxide, carbon dioxide, nitrogen, residual ammonia, residual methane, and water. Natural gas is typically used as the source of methane while air, oxygen-enriched air, or pure oxygen can be used as the source of oxygen. The catalyst is typically a wire mesh platinum/rhodium alloy or a wire mesh platinum/iridium alloy. Other catalyst compositions can be used and include, but are not limited to, a platinum group metal, platinum group metal alloy, supported platinum group metal or supported platinum group metal alloy. Other catalyst configurations can also be used and include, but are not limited to, porous structures, wire gauze, tablets, pellets, monoliths, foams, impregnated coatings, and wash coatings. In the BMA process, methane and ammonia are reacted using a platinum catalyst as described in US Pat. No. 7,429,370 and incorporated by reference herein.

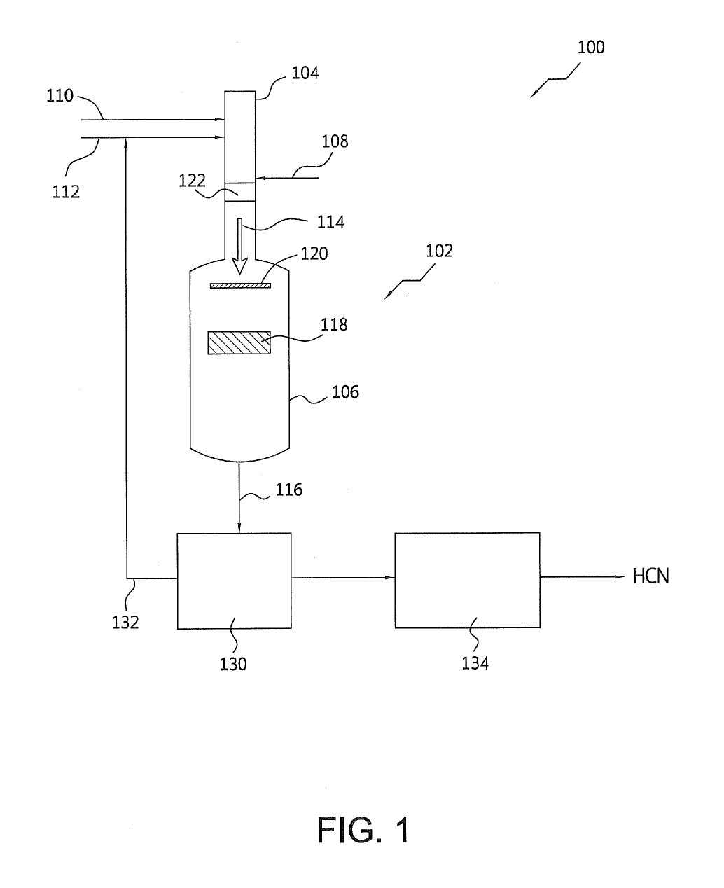

In general, FIG. 1 shows a HCN synthesis system 100. Generally, the HCN is produced in a reaction assembly 102 that includes a mixing vessel 104 and a reactor vessel 106. In the Andrussow process, the reactant gases, which include an oxygen-containing gas feed stream 108, a methane-containing gas feed stream 110, and an ammonia-containing gas feed stream 112, are introduced into mixing vessel 104. Mixing vessel 104 comprises at least one flow straightener 122, as described herein. Methane-containing gas feed stream 110 and an ammonia-containing gas feed stream 112 may be fed above the oxygen-containing gas feed stream 108 as shown in FIG. 1. In some embodiments, methane-containing gas feed stream 110 and ammonia-containing gas feed stream 112 may be combined prior to being introduced to mixing vessel 104. In one embodiment, mixing vessel 104 may contain one or more static mixing zones, as described further herein, for producing a thoroughly mixed ternary gas mixture 114. The static mixing zones may be downstream of flow straighteners 122. Mixing vessel 104 has straight walls that are aligned with the flow of the ternary gas mixture 114 into reaction vessel 106.

Ternary gas mixture 114 exits mixing vessel 104 and contacts a catalyst contained within reactor vessel 106 to form a crude hydrogen cyanide product 116 containing HCN. The catalyst may be within a catalyst bed 118. In one embodiment, a distributor plate 120 may be used to convey ternary gas mixture 114 into reactor vessel 106. Distributor plate 120 may also be used to evenly distribute the ternary gas mixture and further mix ternary gas mixture as needed. Ammonia can be recovered from crude hydrogen cyanide product 116 in an ammonia recovery section 130 and returned via line 132. The HCN can be further refined in an HCN refining section 134 to a purity required for the desired use. In some embodiments, the HCN may be a high purity HCN containing less than 100 mpm by weight water.

Reactant gases 108, 110, and 112 are introduced at an angle that may range from 5 to 90°, and is generally about perpendicular to the flow of ternary gas mixture 114 in mixing vessel 104. This may induce rotation of the reactant gases that produces an undesirable flow pattern. An undesirable flow pattern may result in a decrease of productivity of HCN and lower yields of HCN. The present invention advantageously improves performance by reducing rotational flow in mixing vessel 104 by using at least one flow straightener 122 to obtain a plug flow that is substantially free of rotation and to allow for a thoroughly mixed ternary gas mixture 114. This improves yields by achieving a substantially uniform bed temperature across the catalyst bed. A uniform bed temperature avoids differences caused by hot or cold spots on the catalyst bed. A catalyst bed that experiences large variances in bed temperature may be susceptible to cracking that may lead to reactant bypass and productivity loss.

Flow straightener 122 may provide a plug flow with little to substantially no rotation of the reactant gases in the mixing vessel prior to mixing the reactant gases. Preferably the plug flow has a substantially uniform velocity profile across the flow straightener 122. This reduces any rotation that may be introduced by feeding the reactant gases into mixing vessel 104.

In addition, reactant gases may tend to flow through the middle of mixing vessel 104, thus concentrating in the center area, leaving the walls of mixing vessel 104 with less flow of reactant gases, and resulting in poor mixing of the oxygen-containing gas with the methane-containing gas and ammonia-containing gas. The static mixers extend transversely from the internal wall of the mixing vessel, thus leaving the middle of the mixing vessel open. Thus, there may be poor mixing when the reactant gases are not evenly distributed across the circumferential diameter of the mixing vessel. Flow straighteners 122 of the present invention have a center body to diffuse the reactant gases away from the center and out towards the walls of the mixing vessel. The center body is typically positioned to at least partially overlap with the centerline of the mixing vessel. The center body advantageously improves mixing by denying flow through the middle of the mixing vessel. The center body is preferably conical-shaped or pyramidal-shaped.

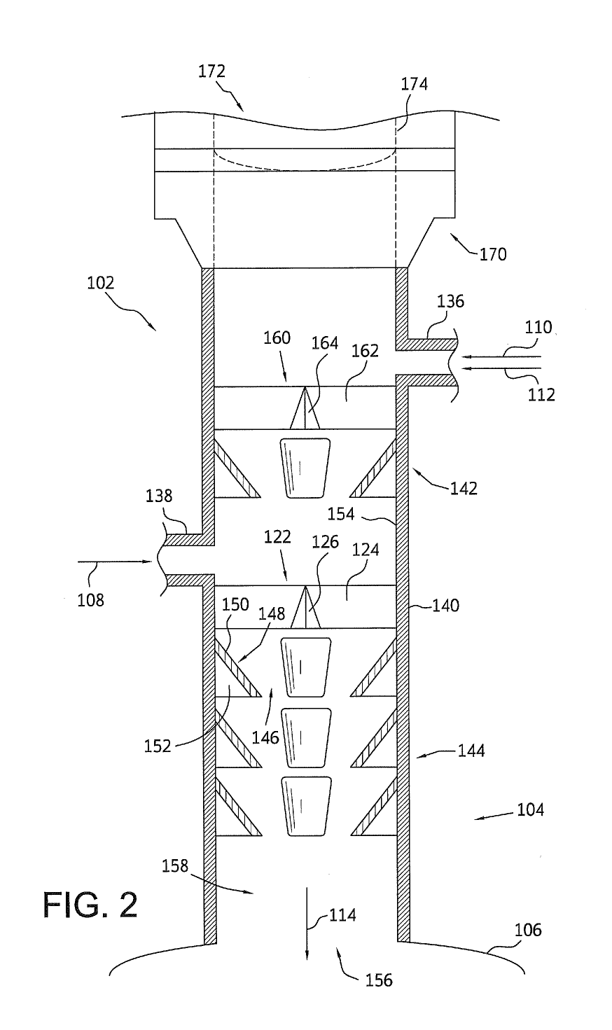

In FIG. 2, there is shown a cross-section view of a mixing vessel 104 having flow straightener 122 and flow straightener 160. Mixing vessel 104 produces a ternary gas mixture 114, preferably that is thoroughly mixed, through the downstream end 156 and into HCN reactor vessel 106. Mixing vessel 104 comprises an elongated conduit 140 that may meet or extend into reactor vessel 106 and in the flow direction of ternary gas mixture 114. The size of the mixing vessel may vary, but may have a length of 1 m to 5 m, e.g., from 1.2 to 2.5 m, and an internal diameter of 5 to 60 cm, e.g., from 10 to 35 cm. In one embodiment, there is a first inlet port 136, also referred to as an upper inlet, for introducing at least one reactant gas selected from the group consisting of a methane-containing gas, an ammonia-containing gas, an oxygen-containing gas, and mixtures thereof. Preferably, a methane-containing gas 110 and an ammonia-containing gas 112 are introduced through first inlet port 136. Flow straightener 160 may be positioned downstream to first inlet port 136 and produces a plug flow of the reactant gases introduced through first inlet port 136.

Additional reactant gases may also be introduced into conduit 140 through a second inlet port 138, also referred to as a lower inlet. Flow straightener 122 may be positioned downstream to second inlet port 138 and produces a plug flow of the reactant gases introduced through second inlet port 138 and those reactant gases from the first inlet port 136. In one embodiment, the reactant gas introduced through second inlet port 138 may be selected from the group consisting of a methane-containing gas, an ammonia-containing gas, an oxygen-containing gas, and mixtures thereof. Preferably, an oxygen-containing gas stream 108 may be introduced. As shown in FIG. 2, second inlet port 138 is downstream to the first inlet port 136. Because the ternary gas mixture is not formed until oxygen-containing gas is introduced, it is preferred to introduce oxygen-containing gas 108 lower in conduit 140 to reduce the volume of ternary gas mixture 114.

Flow straightener 122 comprises one or more radial plates 124 that are mounted to a center body 126. Flow straightener 122 has a unibody assembly and radial plates 124 are rigidly affixed to center body 126. A suitable stainless steel such as 310SS or 316SS may be used for flow straightener 122. The size of flow straightener 122 may vary depending on the size of the mixing vessel. In one aspect, there may be from 1 to 10 radial plates 124, e.g., preferably from 2 to 6 radial plates. Center body 126 may be concentrically located within elongated conduit 140. Center body 126 may be positioned in elongated conduit 140 such that the radial plates are aligned with the tabs 148 or offset, such as at a 45° angle. In one aspect, flow straightener 160 may have a similar structure as flow straightener 122.

Radial plates 124 have a smooth surface that extends in the direction of the flow the ternary gas mixture 114, i.e. extending lengthwise in elongated conduit 140. Because radial plates extend across the diameter of conduit, each radial plate has a length that is about half of the conduit diameter. Each radial plate 124 has a height that is from 0.05y to 0.3y, wherein y is the diameter of the conduit. An exemplary flow straightener 122 may have radial plates having a height from 1 to 20 cm, e.g., from 4 to 16 cm, and a thickness of 0.1 to 3 cm, e.g., from 0.5 to 1.5 cm. Each radial plate may have a rounded upstream edge that is equilateral with an upstream point of center body 126. In some aspects, the upstream edge may be tapered, knife-edged, squared, or blunted. The radial plates of both flow straighteners 122 and 160 may have similar dimensions and shape.

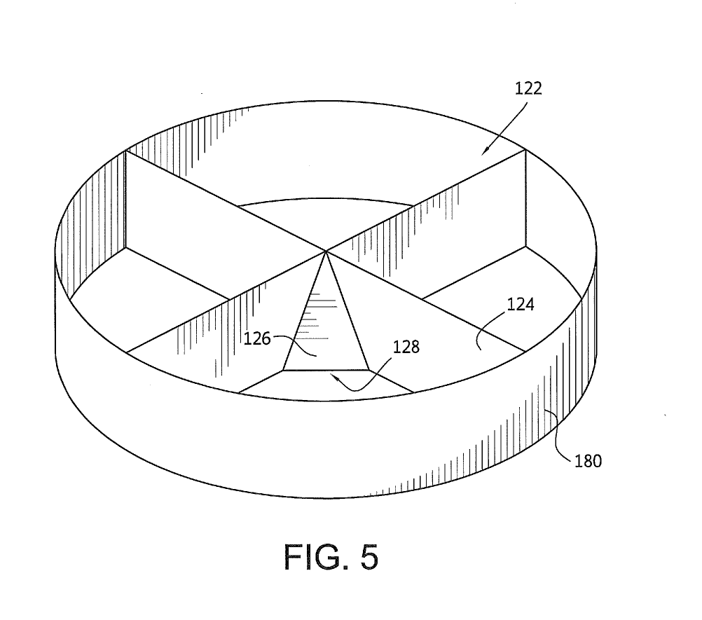

In one embodiment, radial plates 124 extend outward from center body 126 and are connected to internal wall 154 of elongated conduit 140. In one embodiment, as shown in FIG. 5, radial plates 124 may extend outward and connect to an annular ring 180. Annular ring 180 may be connected to internal wall 154 of elongated conduit. In one aspect, annular ring 180 may be slip-fitted to internal wall 154, welded to, or otherwise adhered to internal wall 154.

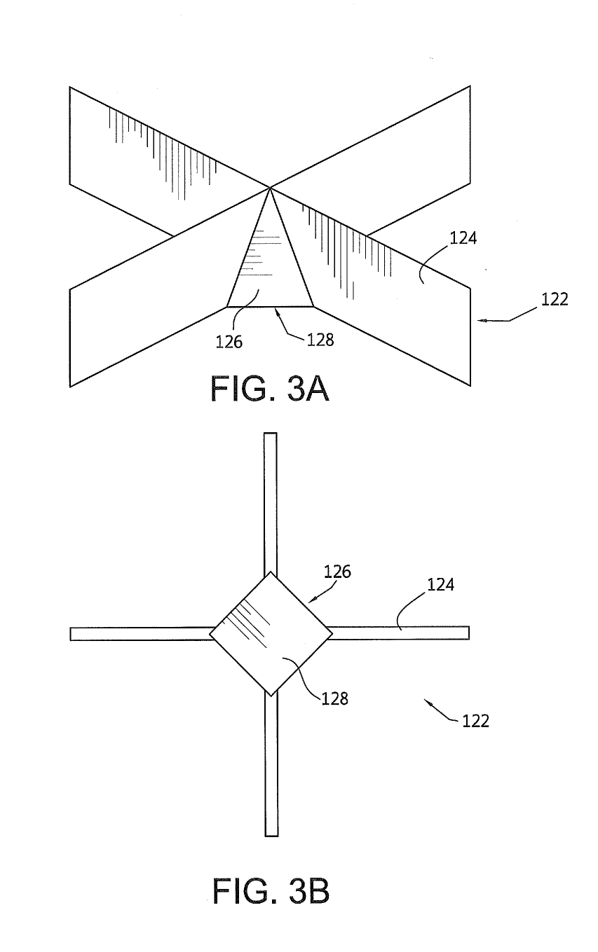

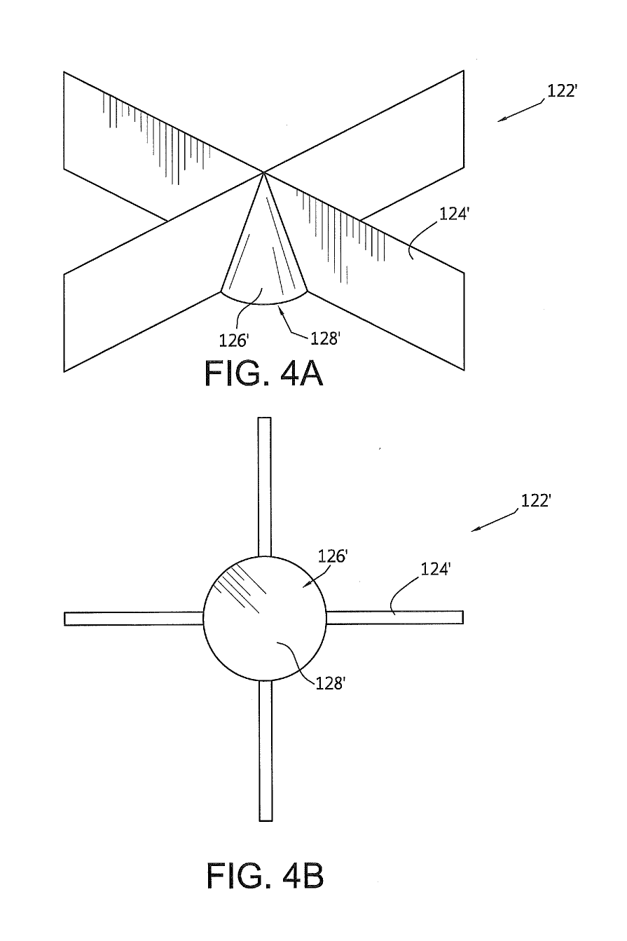

Center body 126 tapers from upstream edge to downstream base 128 at an angle from 5° to 65°. As shown in FIGS. 3A/3B and 4A/4B center body 126, 126′ may have a variety of shapes, including but not limited to cones, pyramids, prisms, trapezoids, etc. Center body 126 may be solid or hollow. Center body 126 has a downstream base 128 that may be a circle, triangle, square, diamond, rectangle, pentagon, or hexagon. FIG. 3B represents a square downstream base 128 of a pyramidal shaped center body 126. When center body 126 is a pyramidal shape, radial plates 124 may meet the corners of the pyramid. FIG. 4B represents a circle downstream base 128′ of a cone shape 126′. Radial plates 124′ in FIGS. 4A/4B may be spaced equidistance from each other on the cone shaped center body 126′. In one embodiment, the downstream base has a maximum diameter that is from 0.1*x to 0.5*x, wherein x is the radial length of the radial plates.

Elongated conduit 140 further comprises one or more static mixing zones 142 and 144 for producing a thoroughly mixed ternary gas mixture 114. As shown in FIG. 2, each static mixing zone 142 and 144 is downstream or downstream from flow straighteners 160 and 122, respectively. In one embodiment, there is a first static mixing zone 142 located adjacent to first inlet port 136. First static mixing zone 142 may also be spaced apart from flow straightener 160. Flow straightener 160 may have a configuration of radial plates 162 and center body 164 that is similar to flow straightener 122. In some embodiments, flow straightener 160 may lack a center body and comprise only radial plates 162 that adjoin in a center region.

First static mixing zone 142 provides for a mixing of the methane-containing gas 110 and ammonia-containing gas 112 prior to being mixed with the oxygen-containing gas. First static mixing zone 142 may form a binary gas of methane and ammonia. Prior to mixing the binary gas with the oxygen-containing gas, it is preferred to have the reactant gases pass through flow straightener 122 to provide a plug flow having a substantially uniform velocity profile to second static mixing zone 144. Second static mixing zone 144 is located adjacent to or downstream to second inlet port 138 and preferably spaced apart from flow straightener 122. Second static mixing zone 144 mixes the oxygen-containing gas with the other reactant gases to produce ternary gas mixture 114.

In one embodiment, second static mixing zone 144 may be installed as close as is practical to the reactor catalyst bed (not shown) in reactor vessel 106 so that the volume and the residence time of the ternary gas mixture in the mixing vessel 104 are minimized.

Although one inlet is shown for ports 136 and 138 in FIG. 2, in one embodiment there may be a plurality of first inlet ports and second inlet ports. There may be multiple feed entries around the entire circumference of elongated conduit 140. Each of the feed entries may be at an angle of 5 to 90° to the flow direction of the ternary gas mixture. The main feed line of reactants may be connected to an annular zone (not shown) surrounding the plurality of first inlet ports and/or second inlet ports. There may be a plurality of holes (not shown) that defines the inlet port and provides a feed entry from the annular zone into elongated conduit 140. Without being bound by theory, it is believed that the plurality of holes may further prevent rotation, i.e. swirling, when the reactants are fed to mixing vessel 104.

In another embodiment, first inlet port(s) 136 and second inlet port(s) 138 may extend into the cavity of elongated conduit 140. This may allow the reactants to be introduced into the middle of elongated conduit 140. Without being bound by theory, it is believed that the extended inlet may prevent the reactants from passing through mixing vessel 104 without contacting tabs 148. Preferably the second inlet port 138, which feeds oxygen, is extended into the middle of conduit 140.

Static mixing zones 142 and 144 each comprise one or more rows 146 of tabs 148. Due to the decreased rotational flow of the ternary gas mixture produced by flow straighteners 122 and 160, the mixing caused by tabs 148 is greatly improved. In addition, this improved mixing is due to the flow straighteners having a center body to deny flow of the ternary gas through the middle of the conduit and forces the ternary gas mixture to contact the tabs extending from the internal walls. Each static mixing zone 142 and 144 may comprise from one to ten rows of tabs 148. In one embodiment, the number of rows in second static mixing zone 144 may be greater than or equal to the number of rows in first static mixing zone 142. For example, second static mixing zone 144 may have from one to three rows. Each row 146 may comprise from one to ten tabs 148, and it is preferred to include from two to six tabs 148. Within each row 146, tabs 148 are preferably evenly spaced around the circumference of conduit 140. As the number of rows and/or number of tabs in each row increase the pressure drop in the mixing vessel would also increase. Thus, it is desirable to use a combination of rows and tabs that provides thorough mixing while maintaining a pressure drop of less than 35 kPa, e.g., less than 25 kPa. This low pressure drop indicates that less energy is used to mix the reactants which would typically be expected to indicate poor mixing. However, due to the low CoV achieved by eliminating rotational flow, the ternary gas mixture formed using less energy can achieve similar performance to a higher energy process with a larger pressure drop.

Downstream to second static mixing zone 144 and before the outlet 156 of mixing vessel 104 there may be an empty space 158. Empty space 158 allows a non-mixing area for the ternary gas mixture. Empty space 158 may have a height that is from 0.1*d to 10*d, wherein d is the internal diameter of elongated conduit 140.

In one embodiment, tabs may be mounted to internal wall 154 or inserted through a slot (not-shown) in internal wall 154 and welded to the external surface of elongated conduit 140. Each tab 148 may have a support 152 that is in an I-shape, I-shape, T-shape, U-shape, or V-shape. Support 152 may provide rigidity to tab 148 to prevent deforming under pressure change due to upsets in the reactor. The upsets may cause a dramatic rise in pressure of greater than 5 MPa, e.g., greater than 13 MPa.

In one embodiment, tab 148 has an upstream surface 150 that is angled in the flow direction. The angle may vary from 5° to 45°, and more preferably from 20° to 35°. Downstream surface may have a similar angle as upstream surface. The tabs within a row may have a substantially similar angle, e.g. within ±5°, and more preferably within ±1°. The angle in the tabs between adjacent rows may vary, as well as between the different mixing zones. In one exemplary embodiment, first mixing zone 142 may have tabs with an angle of 30° and second mixing zone 144 may have tabs with an angle of 25°. In another exemplary embodiment, first static mixing zone 142 may have tabs with an angle of 30° and second static mixing zone 144 may have tabs with an angle of 45°.

In one embodiment, tabs 148 preferably lack cant, i.e. are not twisted, and are aligned on the internal wall of conduit 140 to be substantially in parallel with the flow of the ternary gas mixture. In one embodiment, the cant of tabs 148 is from 0° to 7°, e.g., from 0° to 3°. Having a slight cant of greater than 8° may result in poor mixing performance that may lead to increases in bed temperature variations and/or undesirable pressure drop increases.

Tabs 148 within conduit 140 operate as fluid foils that, with reactant gases flowing through mixing vessel 104, have greater fluid pressures manifest against their upstream surfaces 150 and reduced fluid pressures against their downstream surfaces. Flow straightener 122 provides a plug flow of the reactant gases to be contacted against the upstream surfaces 150. This pressure difference in the fluid on adjacent, mutually opposed faces of each of the tabs 148, causes the longitudinal flow over and past each tab 148 to be redirected, thereby resulting in the addition of a radial cross-flow component to the longitudinal flow of fluid through the conduit 140. The fluid flow over the edges of each tab results in the flow being deflected inward and up by the angled upstream face to generate pairs of oppositely rotating predominantly streamwise vortices at the tips of each tab, and downstream hairpin vortices interconnecting adjacent streamwise vortices generated by a single tab. The vortices of each such pair have mutually opposed rotations, about an axis of rotation oriented generally along the longitudinal stream-wise fluid flow direction, along the annular space between the two boundary surfaces. The turbulent mixing generated by static mixing zones 142, 144 produces a thoroughly mixed ternary gas having a co-efficient of variation (CoV) of less than 0.1.

The shape of upstream surface 150 of the tabs 148 may include trapezoid, square, parallelogram, semi-ellipsoid, rounded square, or rectangular. A tapered tab such as a trapezoid may be used. In addition, tabs may be slightly bent or curved. In one embodiment, the lengthwise dimension of the tab, in the direction of the main streamwise flow, does not exceed twice the width of the tab.

The dimensions of mixing vessel 104 can vary widely and will be dependent, to a large degree, on the capacity of reactor vessel 106. In one exemplary embodiment of the invention disclosed herein, mixing vessel 104 has an outside length to diameter ratio in the range from 2 to 20, for example from 2 to 10.

Although there are two inlet ports and two static mixing zones shown in FIG. 2, in other embodiments there may be one inlet port having one static mixer. In addition, there may be two inlet ports having one static mixer located downstream to the lower inlet port. Other configurations of inlet ports and static mixers may be used within the scope of the present invention.

The ternary gas mixture 114 may pass from mixing vessel 104 into the inlet port of reactor vessel 106. In one embodiment, there may be one or more distributor plates for providing an evenly distributed ternary gas mixture on the catalyst bed. A flame arrester may also be used in combination with the distributor plates to distribute the ternary gas on the catalyst bed. Preferably, the distributor plate should not cause a pressure drop in the reactor vessel of greater than 35 kPa, e.g. more preferably a pressure drop of less than 25 kPa. In one embodiment, there is one distributor plate being disposed within the reactor vessel downstream of the inlet and upstream of the flame arrester. The distributor plate may have a diameter that is greater than the inlet port and less than a maximum diameter of the reactor vessel. The distributor plate has a void area, formed by one or more holes, that is at least 50% to 80% of the area of the distributor plate. The void area may have a raised, conical-shaped, feature on the upstream surface to diffuse the ternary gas mixture. The distributor plate may also comprise a solid area that is aligned, preferably concentrically aligned, with a centerpoint of the inlet port. In one embodiment, the distributor plate may be a wire mesh material.

In other embodiments, the static mixing zone may be a vortex-generating tab mixer. VORTAB® is a suitable passive mixing element which is used in high-efficiency static mixers available from Chemineer, Inc. as part of the HEV (high efficiency vortex) product line. Generally, HEV mixers comprise trapezoidal tabs mounted at an angle to a mixer housing and generating tip vortices with alternating rotations to mix a passing fluid stream with minimal pressure loss while maintaining a relatively flat velocity profile associated with turbulent flow.

A thoroughly mixed ternary gas for the purposes of the present invention has a coefficient of variation (CoV) that is less than 0.1 across the diameter of the catalyst bed, or more preferably less than 0.05 and even more preferably of less than 0.01. In terms of ranges, the CoV may be from 0.001 to 0.1, or more preferably from 0.001 to 0.05. Low CoV beneficially increases the productivity of reactants being converted to HCN. CoV is defined as the ratio of the standard deviation, r, to the mean, μ. Ideally, CoV would be a low as possible, for example less than 0.1, for example, 0.05. The HCN unit may operate above a CoV of 0.1, and CoV of 0.2 is not unusual, i.e. ranging from 0.01 to 0.2 or from 0.02 to 0.15, but above 0.1 the operating cost is higher and HCN yield is lower, for example 2% to 7% lower, translating into a lost opportunity of millions of dollars per year in continuous commercial operation. A thoroughly mixed ternary gas advantageously increases the productivity of HCN and returns higher yields of HCN. Performance improvement can be obtained by achieving a substantially uniform bed temperature across the catalyst bed.

When CoV exceeds 0.1, the reactant gases may be in concentrations that are outside the safe operating ranges for the catalyst bed. For example, when operating at higher oxygen concentrations in the ternary gas, a larger CoV may create an increase in oxygen that results in a flashback. In addition, when CoV is larger the catalyst bed may be exposed to more methane, which may lead to a buildup of carbon deposits due to oxidation. The carbon deposits may decrease catalyst life and performance. Thus, there may be a higher raw material requirements with larger CoV.

The mixing vessel may be operated at a temperature from 50° C. to 120° C. Higher temperatures may be used in the mixing vessel with preheating of the reactant gases. In one embodiment, it is preferred that the mixing vessel is operated below the temperature of the reactor vessel. The operating pressure of the mixing vessel may vary widely from 130 to 400 kPa, and more preferably from 130 to 300 kPa. In general, the mixing vessel may operate at a similar pressure as the reactor vessel.

The reactant gases are mixed under conditions that minimize the pressure drop within the mixing vessel. In one embodiment, the pressure drop in the mixing vessel is less than 35 kPa, preferably less than 25 kPa. Minimizing the pressure drop may reduce the maximum pressure of the ternary gas and thus reduce potential pressure in the event of a detonation. Reducing the pressure drop also minimizes the energy associated with mixing (i.e., compression energy).

The reactant gases are supplied to a mixing vessel to provide a ternary gas mixture having a molar ratio of ammonia-to-oxygen from 1.2 to 1.6, e.g., from 1.3 to 1.5, a molar ratio of ammonia-to-methane from 1 to 1.5, e.g., from 1.10 to 1.45, and a molar ratio of methane-to-oxygen of 1 to 1.25, e.g., from 1.05 to 1.15. For example, a ternary gas mixture may have a molar ratio of ammonia-to-oxygen of 1.3 and methane-to-oxygen 1.2. In another exemplary embodiment, the ternary gas mixture may have a molar ratio of ammonia-to-oxygen of 1.5 and methane-to-oxygen of 1.15. The oxygen concentration in the ternary gas mixture may vary depending on these molar ratios. Thus, in some embodiments, the ternary gas mixture comprises at least 25 vol.% oxygen, e.g., at least 28 vol. % oxygen. In some embodiments, the ternary gas mixture comprises from 25 to 32 vol. % oxygen, e.g., from 26 to 30 vol. % oxygen. Various control systems may be used to regulate the reactant gas flow. For example flow meters that measure the flow rate, temperature, and pressure of the reactant gas feed streams and allow a control system to provide “real time” feedback of pressure-and temperature-compensated flow rates to operators and/or control devices may be used.

As will be appreciated by one skilled in the art, the foregoing functions and/or process may be embodied as a system, method or computer program product. For example, the functions and/or process may be implemented as computer-executable program instructions recorded in a computer-readable storage device that, when retrieved and executed by a computer processor, controls the computing system to perform the functions and/or process of embodiments described herein. In one embodiment, the computer system can include one or more central processing units, computer memories (e.g., read-only memory, random access memory), and data storage devices (e.g., a hard disk drive). The computer-executable instructions can be encoded using any suitable computer programming language (e.g., C++, JAVA, etc.). Accordingly, aspects of the present invention may take the form of an entirely software embodiment (including firmware, resident software, micro-code, etc.) or an embodiment combining software and hardware aspects.

In one embodiment, when mixing the reactant gases, it is desirable to avoid side reactions in the mixing vessel. The side reactions may include oxidation of the methane or ammonia. The deflagration or risk and impact of a detonation under adverse operating conditions should also be avoided in the mixing vessel by maintaining a flow velocity in the mixing vessel that is greater than the flamefront of the ternary gas. The term “deflagration” as used herein refers to a combustion wave propagating at subsonic velocity relative to the unburned gas immediately ahead of the flame. “Detonation” refers to a combustion wave propagating at supersonic velocity relative to the unburned gas immediately ahead of the flame. Deflagrations typically result in modest pressure rise whereas detonations can lead to extraordinary pressure rise. The present invention provides an advantageous solution to quickly and thoroughly mix the reactant gases while minimizing the pressure drop during mixing and avoiding unwanted side reactions such as oxidation and deflagration.

The materials of construction for the mixing vessel and flow straightener may vary and can be any material compatible with the ternary gas mixture, capable of withstanding design temperatures and pressures in the mixing vessel without significant degradation, and that does not promote reaction of the gases in the ternary gas mixture. Satisfactory results have been obtained using stainless steel materials of construction including 310SS and 316SS.

In one embodiment, catalytic activity of the mixer interior surfaces is reduced by polishing those surfaces exposed to gas flow to reduce the specific surface area (roughness) of the interior surfaces. For example, machining the internal diameter of the mixing vessel to a surface roughness rms of about 125 microinches (3.2 micrometers) significantly reduces the catalytic activity.

Mixing vessel 104 may be provided with one or more suitable analyzers for measuring the concentration of methane and ammonia exiting first static mixing zone 142 and/or second static mixing zone 144. Such on-line and off-line analyzers are well known in the art. Nonlimiting examples of such analyzers include infrared analyzers, Fourier transform infrared analyzers, gas chromatography analyzers, and mass spectrometry analyzers. Likewise, second static mixing zone 144 may be provided with one or more suitable analyzers for measuring the oxygen concentration in the ternary gas mixture.

In an optional embodiment not shown in FIG. 2, upper and lower inlets 136 and 138 are provided with inert gas connections with automatic valves so that the lines to mixing vessel 104 can be purged of reactants when necessary, such as for maintenance shutdowns or reactor shutdowns.

At an upstream end of mixing vessel 104, there is provided a pressure relief regulator 170, which is more fully discussed herein. A pressure relief regulator 170, such as a rupture disk, can be installed in a vent line 172 of mixing vessel 104. The pressure relief regulator 170 limits the pressure in the elongated conduit 140, and hence the total mass and potential energy contained between the first static mixing zone 142 and the catalyst bed (not shown), thereby reducing the impact of a deflagration or risk and impact of a detonation under adverse operating conditions. In one embodiment, the pressure relief regulator 170 has a pressure release setpoint from 110% to 115% of an operating pressure of mixing vessel 104.

Good results have been obtained when the pressure relief regulator 170 is supported on an upstream end of first static mixing zone 142 so as to be in communication with the vent line 172 that can extend to a stack 174. Thus, upon excess pressure buildup in mixing vessel 104, the pressure relief regulator 170 opens and the heated gases are vented from reaction vessel 106 and mixing vessel 104. A nitrogen purge stream can be used to purge the vapor volume proximate pressure relief regulator 170.

In the production of HCN, the reactant gases are each processed through suitable feed preparation systems. The source of the respective reactant gases may be delivered to each respective feed preparation system via any suitable delivery system known in the art, such as pipeline, truck, boat, or rail, and the like.

An oxygen-containing source can be supplied from the oxygen feed preparation system that includes equipment to regulate the pressure of the oxygen-containing source introduced into the process, and a filter to remove fine particles from an unfiltered oxygen-containing source. Increasing the oxygen content of the oxygen-containing source can be advantageous for increasing the reaction yield and reducing the size of process equipment. Increasing the oxygen content of air also increases the flammability of substances normally flammable in air. Entrained metallic particles (such as iron or steel) and/or other contaminants and by-products in the feed stream can cause oxygen piping fires if not removed. Any suitable mechanism can be used for removal of the entrained metallic particles and other contaminants from the unfiltered oxygen-containing source, such as, for example, filtration, cyclone separators, coalescers, demisters, and mist eliminators. When the source of oxygen-containing feed gas requires compression, use of oil-free compressors and seal designs known to those skilled in the art can also lessen contamination. The oxygen-containing gas may comprise air, oxygen-enriched air, or pure oxygen. For oxygen-enriched air, a compressor may be needed.

The term “air” as used herein refers to a mixture of gases with a composition approximately identical to the native composition of gases taken from the atmosphere, generally at ground level. In some examples, air is taken from the ambient surroundings. Air has a composition that includes approximately 78 vol. % nitrogen, approximately 21 vol. % oxygen, approximately 1 vol. % argon, and approximately 0.04 vol. % carbon dioxide, as well as small amounts of other gases.

The term “oxygen-enriched air” as used herein refers to a mixture of gases with a composition comprising more oxygen than is present in air. Oxygen-enriched air has a composition including greater than 21 vol. % oxygen, less than 78 vol. % nitrogen, less than 1 vol. % argon and less than 0.04 vol. % carbon dioxide. In some embodiments, oxygen-enriched air comprises at least 28 vol. % oxygen, e.g., at least 80 vol. % oxygen, at least 95 vol. % oxygen, or at least 99 vol. % oxygen.

Using a high oxygen concentration in the oxygen-containing source (i.e., low concentration of inerts such as nitrogen) offers the opportunity to reduce the size and operating cost of downstream equipment that would otherwise be necessary to process a large volume of inert nitrogen. In one embodiment, the oxygen-containing gas comprises greater than 21 vol. % oxygen, e.g. greater than 28 vol. % oxygen, greater than 80 vol. %, greater than 90 vol. %, greater than 95 vol. % or greater than 99 vol. % oxygen.

The purity of the methane-containing source becomes increasingly important as the oxygen content of the oxygen-containing source increases. As would be understood by one of ordinary skill in the art, the source of the methane may vary and may be obtained from renewable sources such as landfills, farms, biogas from fermentation, or from fossil fuels such as natural gas, oil accompanying gases, coal gas, and gas hydrates as further described in VN Parmon, “Source of Methane for Sustainable Development”, pages 273-284, and in Derouane, eds. Sustainable Strategies for the Upgrading of Natural Gas: Fundamentals, Challenges, and Opportunities (2003). For purposes of the present invention, the methane purity and the consistent composition of the methane-containing source is of significance. In some embodiments, the process may comprise determining methane content of the methane-containing source and purifying the methane-containing source when the methane content is determined to be less than 90 vol. %. Methane content may be determined using gas chromatograph-based measurements, including Raman Spectroscopy. The methane content may be determined continuously in real time or as needed when new sources of methane-containing sources are introduced into the process. In addition, to achieve higher purities, the methane-containing source may be purified when the methane content is above 90 vol. %, e.g., from 90 to 95 vol. %. Known purification methods may be used to purify the methane-containing source to remove oil, condensate, water, C2+hydrocarbons (e.g., ethane, propane, butane, pentane, hexane, and isomers thereof), sulfur, and carbon dioxide. The methane may be delivered to the HCN synthesis system in a purified state, in a semi-purified state, or in an impure state.

Natural gas, for example, is an impure state of methane. That is, natural gas is a substantially methane-containing gas that can be used to provide the carbon element of the HCN produced in the process of the present invention. However, in addition to methane, natural gas may contain contaminants such as hydrogen sulfide, carbon dioxide, nitrogen, water and higher molecular weight hydrocarbons, such as ethane, propane, butane, pentane, etc., all of which are, when present, detrimental to the production of HCN. Natural gas composition can vary significantly from source to source. The composition of natural gas provided by pipeline can also change significantly over time and even over short time spans as sources are taken on and off of the pipeline. Such variation in composition leads to a difficulty in sustaining optimum and stable process performance. The sensitivity of the HCN synthesis process to these variations becomes more severe as inert loading is reduced through oxygen enrichment of the oxygen-containing source.

The methane-containing source can be supplied from a methane feed preparation system that includes equipment to concentrate the methane, remove higher molecular weight hydrocarbons, carbon dioxide, hydrogen sulfide and water from the natural gas, and filter the natural gas to remove fine particles. Purification of, for example, the natural gas provides a methane-containing gas feed stream highly concentrated in methane and with greatly reduced variability in the composition and fuel value. The purified methane-containing gas feed stream, when mixed with the oxygen-containing gas feed stream and ammonia-containing gas feed stream, provides the ternary gas mixture that reacts more predictably during the synthesis of HCN compared to use of an unpurified methane-containing gas feed stream. More consistent purification and control of the methane-containing gas stabilizes the process and allows determination and control of optimum molar ratios of methane/oxygen and ammonia/oxygen which, in turn, leads to a higher yield of HCN.

Using purified natural gas to obtain the methane-containing gas feed stream, i.e., one containing substantially pure methane, to produce HCN also increases the catalyst life and yield of HCN. In particular, using the substantially pure methane-containing gas feed stream: (1) reduces the concentration of impurities, such as sulfur, CO₂, and H₂O, that have either a detrimental effect downstream or have no process benefit; (2) stabilizes the remaining composition at a consistent level to (a) allow downstream HCN synthesis to be optimized, and (b) enables the use of highly enriched or pure oxygen feed streams by mitigating large temperature excursions in the HCN synthesis step that are typically related to variation in higher hydrocarbon content and are detrimental to optimum yield and operability (such as catalyst damage, interlock, and loss of uptime), and; (3) reduces higher hydrocarbons (i.e., C₂ and higher hydrocarbons) to minimize formation of higher nitriles such as acetonitrile, acrylonitrile, and propionitrile in the synthesis reaction, and the associated yield losses of HCN during removal of nitriles.

In addition, use of the substantially pure methane-containing gas feed stream (1) eliminates or minimizes variability in the feed stock (i.e., it stabilizes the carbon and hydrogen content as well as the fuel values) and thereby stabilizes the entire HCN synthesis system 100 allowing for the determination and control of optimum methane/oxygen and ammonia/oxygen molar ratios for stable operation and the most efficient HCN yield; (2) eliminates or minimizes related temperature spikes and resulting catalyst damage; and (3) minimizes carbon dioxide thereby reducing the amount of carbon dioxide found in an ammonia recovery process and in a recovered or recycled ammonia stream coming from an ammonia recovery process, that may be downstream of reactor vessel. Eliminating or minimizing the carbon dioxide in such an ammonia recovery process and in a recovered or recycled ammonia stream reduces the potential for carbamate formation that causes plugging and/or fouling of the piping and other process apparatuses.

Prior to being mixed in mixing vessel with oxygen-containing gas feed stream and methane-containing gas feed stream, a “make up” or fresh ammonia stream is processed through the fresh ammonia feed preparation system. Generally, the primary function of the fresh ammonia feed preparation system is to remove contaminants, such as water, oil, and iron, from the fresh ammonia stream prior to introduction of the ammonia-containing gas feed stream into the mixing vessel. Contaminants in the ammonia-containing gas feed stream can reduce catalyst life that results in poor reaction yields. The fresh ammonia feed preparation system can include process equipment, such as vaporizers, and filters for the “make up” or fresh ammonia stream to provide a treated fresh ammonia stream.

For example, commercially available liquid ammonia can be processed in a vaporizer to provide a partially purified ammonia vapor stream and a first liquid stream containing water, iron, iron particulate and other nonvolatile impurities. An ammonia separator, such as an ammonia demister, can be used to separate the impurities and any liquid present in the partially purified ammonia vapor stream to produce the treated fresh ammonia stream (a substantially pure ammonia vapor stream) and a second liquid stream containing entrained impurities and any liquid ammonia present in the partially purified ammonia vapor stream.

In one embodiment, the first liquid stream containing water, iron, iron particulate and other nonvolatile impurities is fed to a second vaporizer where a portion of the liquid stream is vaporized to create a second partially purified ammonia vapor stream and a second, more concentrated, liquid stream containing water, iron, iron particulate and other nonvolatile impurities that can be further treated as a purge or waste stream. The second partially purified ammonia vapor stream can be fed to the ammonia separator. In another embodiment, the second, more concentrated, liquid stream containing water, iron, iron particulate and other nonvolatile impurities is fed to a third vaporizer to further reduce the ammonia content before treating as a purge or waste stream.

Foaming in the vaporizers can limit the vaporization rate of ammonia and decrease the purity of the ammonia vapor produced. Foaming is generally retarded by the introduction of an antifoaming agent into the vaporizers directly or into the vaporizer feed streams. The antifoaming agents belong to a broad class of polymeric materials and solutions that are capable of eliminating or significantly reducing the ability of a liquid and/or liquid and gas mixture to foam. Antifoaming agents inhibit the formation of bubbles in an agitated liquid by reducing the surface tension of the solutions. Examples of antifoaming agents include silicones, organic phosphates, and alcohols. In one embodiment, a sufficient amount of antifoaming agent is added to the fresh ammonia stream to maintain an antifoaming agent concentration in the range from 2 mpm to 20 mpm in the fresh ammonia stream 180. A nonlimiting example of an antifoaming agent is UNICHEM 7923 manufactured by Unichem of Hobbs, NM.

The fresh ammonia feed preparation system may also be provided with a filter system for removing micro particulates from the treated fresh ammonia stream to prevent poisoning of the catalyst in reactor vessel. The filter system can be a single filter or a plurality of filters.

Ammonia is also separated and recovered in the ammonia recovery section as recycle ammonia stream that can be separately treated in a recycle ammonia feed preparation system. The recycle ammonia feed preparation system can include process equipment for filtering and heating the recycle ammonia stream to produce a treated recycle ammonia stream. Heating the piping carrying recycle ammonia stream helps prevent deposition on the inside piping walls. The treated recycle ammonia stream can be combined with the treated fresh ammonia stream to form the ammonia containing gas feed stream.

The HCN synthesis reaction that occurs in reaction vessel is an exothermic reaction conducted at a reaction temperature in the range of 1000° C. to 1200° C. and a pressure in the range of 100 kPa to 400 kPa. The catalyst is typically a wire mesh platinum/rhodium alloy or a wire mesh platinum/iridium alloy. In one aspect, a 85/15 platinum/rhodium alloy may be used on a flat catalyst support. A 90/10 platinum/rhodium alloy may be used with a corrugated support that has an increased surface area as compared to the flat catalyst support. Other catalyst compositions can be used and include, but are not limited to, a platinum group metal, platinum group metal alloy, supported platinum group metal or supported platinum group metal alloy. Other catalyst configurations can also be used and include, but are not limited to, porous structures, wire gauze, tablets, pellets, monoliths, foams, impregnated coatings, and wash coatings. The catalyst may be loaded in a reaction vessel to a catalyst loading in the range from 0.7 to 1.4 (g catalyst)/(kg feed gas/hr). The ternary gas is contacted with the catalyst in the reaction vessel to provide a reaction product containing hydrogen cyanide.

In one embodiment, the catalyst bed, which is capable of converting the heated ternary gas into HCN, is supported by a support assembly formed of a material capable of reducing platinum-silicide formation and optimizing thermal stress resistance and fouling of tubes of the reactor. The catalyst support assembly is disposed substantially adjacent the catalyst bed. A flame arrester is spatially disposed above the catalyst bed so as to provide a space there between. The flame arrester quenches any upstream burning resulting from flash back within the internal reaction chamber. Ceramic foam is disposed along at least a portion of an interior wall of the housing defining the internal reaction chamber and the catalyst. The ceramic foam minimizes feed gas bypass due to catalyst shrinkage when the reactor is shut down. Ceramic foam disposed above the catalyst bed functions to minimize ternary gas volume, reduce pressure drop and quench formation of radicals during operation of the reactor. Ferrules are disposed in each of the outlets of the housing and provide fluid communication between the catalyst bed and an upper portion of a waste heat boiler. An undersupport having a substantially honeycomb configuration to reduce pressure drop across the undersupport is disposed substantially adjacent a lower surface of the catalyst support.

The flame arrester can be made of any suitable material known in the art as long as the flame arrester is capable of performing any of the functions of: (1) quenching upstream burning in the event of a flashback from the catalyst bed; (2) acts as a flow distributor to assure an even flow across the catalyst bed and to eliminate areas of low gas velocity which could flashback; (3) acts as a space filler to reduce the volume of reactants in the reactor to minimize the potential energy therein; and/or provides thermal insulation between the hot catalyst bed and the ternary gas mixture in the upper portion of the reactor. The flame arrestor employed can be fabricated of a material that: (1) has minimal catalytic effect, (2) is thermally stable at temperatures employed in the manufacture of HCN, (3) will not decompose ammonia, and (4) will not initiate oxidation. Examples of materials which can be employed in the construction of the flame arrester are ceramic refractory materials in any suitable form, including but not limited to: ceramic pills, ceramic foams, ceramic fiber blankets, alumina-silica refractory, non-woven blankets, combinations thereof, and the like. Nonlimiting examples of suitable ceramic refractory material compositions include 90 wt. % alumina and 95 wt. % alumina. Additionally, when pills are used as a material in the construction of the flame arrester, the size and shape of the pills can be varied, provided the pills used in the flame arrester are capable of performing the above referenced functions.

It should be noted that the use of the flame arrester substantially reduces the potential for the heated ternary gas mixture to become detonable through transfer from deflagration to detonation. For example, if it is determined that the flame velocity of the ternary gas mixture at 304 kPa and 100° C. is 1.2 m/sec, then the superficial velocity of preheated ternary gas mixture through the flame arrester, e.g., a pill bed containing ⅜-inch (9.5 mm) diameter pills, should be substantially greater than 1.2 m/sec, thereby preventing a flame from progressing through the pill bed. While the size of the pills used in the pill bed can vary widely, the diameter of the pills is generally from ⅛ inch to ½ inch (3 mm to 13 mm) in size.

Characteristics of the flame arrester, for example the depth of the pill bed, are chosen such that the pressure drop of the preheated ternary gas mixture across the flame arrester is balanced against the increased velocity of the ternary gas mixture and the reduced open space between the flame arrester and the catalyst bed, thereby minimizing the energy potentially released in a deflagration without substantially compromising the backflow to the pressure relief device in the mixing vessel. In one embodiment, the depth of the pill bed is at least 0.4 m.

From the above description, it is clear that the present invention is well adapted to carry out the objects and to attain the advantages mentioned herein as well as those inherent in the presently provided disclosure. While preferred embodiments of the present invention have been described for purposes of this disclosure, it will be understood that changes may be made which will readily suggest themselves to those skilled in the art and which are accomplished within the spirit of the present invention.

The invention can be further understood by reference to the following examples.

### EXAMPLE 1

As illustrated in FIG. 2, a flow straightener having four radial plates and a pyramidal shaped center body as shown in FIGS. 3A-3B is placed in a mixer vessel upstream of the static mixing zone, i.e. upstream of the tabs in a static mixing zone, and downstream of an oxygen-containing gas annular inlet. Mixer vessel has a 25.4 cm diameter and is 214.4 cm in length. A secondary flow straightener also having four radial plates and a pyramidal shaped center body is placed in the mixer vessel upstream of a second static mixing zone and downstream of an inlet for methane-gas and ammonia-gas. Each flow straightener is 10.2 cm in height and has a 0.95 cm thickness. Each flow straightener is constructed of 310SS and has an annular ring that is welded to the inside of the mixer vessel. The flow straighteners prevent rotational flow that contributes to poor mixing. The pyramidal shaped center body blocks the middle of the mixer vessel to prevent the reactants gas from passing through the mixer vessel without being mixed. Each static mixer has tabs. The mixer vessel operates under low energy conditions and the pressure drop is less than 35 kPa. After feeding the reactant gases at an methane-to-oxygen molar ratio of 1.2 and an ammonia-to-oxygen molar ratio of 1:1.5, the ternary gas mixture contains approximately 28.5 vol. % oxygen. As a result of the mixing, the ternary gas mixture has a CoV of less than 0.1. The ternary gas mixture passes into an adjoining reaction vessel having a flame arrester and catalyst bed containing a 85/15 platinum/rhodium catalyst. Under reaction conditions, the catalyst bed has a bed temperature variation from 15° C. to 25° C. across the bed. This bed temperature variation indicates a thoroughly mixed ternary gas mixture.

### EXAMPLE 2

The mixer vessel is operated under similar conditions as Example 1, except that each flow straightener has a cone shaped center body as shown in FIGS. 4A/4B. This flow straightener achieves the same results as Example 1.

### Comparative Example A

A comparison mixer vessel has the same mixer vessel as Example 1, but lacks flow straighteners. Rotation from the reactant gas causes poor mixing. In addition, reactant gases pass through the center of the mixer vessel without being mixed. The ternary gas mixture is formed from the same reactant ratios as Example 1 and contains approximately 28.5 vol. % oxygen. Under similar reaction conditions, there is a larger bed temperature variation in the catalyst bed of 35° C. to 100° C. across the bed. The flow of the ternary gas mixture without a flow straightener is poorly mixed. An increase in bed temperature reduces hydrogen cyanide yield and increases reactant bypass due to cracking in the catalyst bed.

### Comparative Example B

A comparison mixer vessel has the same mixer vessel as Example 1, except the flow straighteners lack a center body. The reactant gases may pass through the center of the mixer vessel without being mixed. The ternary gas mixture is formed from the same reactant ratios as Example 1 and contains approximately 28.5 vol. % oxygen. Under similar reaction conditions as Example 1, there is larger bed temperature variation in the catalyst bed of 35° C. to 100° C. across the bed. The flow of the ternary gas mixture without the center body is poorly mixed. An increase in bed temperature reduces hydrogen cyanide yield and increases reactant bypass due to cracking in the catalyst bed.

### Comparative Example C

A comparison mixer vessel has the same mixer vessel as Example 1, except there is no flow straightener downstream of the annular inlet for the oxygen-containing gas. Rotation of the reactant gases is not prevented once oxygen is combined with methane and ammonia. The ternary gas mixture is formed from the same reactant ratios as Example 1 and contains approximately 28.5 vol. % oxygen. Under similar reaction conditions as Example 1, there is a larger bed temperature variation in the catalyst bed of 35° C. to 100° C. across the bed. The flow of the ternary gas mixture without the flow straightener downstream of the annular inlet for the oxygen is poorly mixed. An increase in bed temperature reduces hydrogen cyanide yield and increases reactant bypass due to cracking in the catalyst bed.

1-15. (canceled)

16. A process for producing hydrogen cyanide, comprising:
(a) introducing a methane-containing gas, an ammonia-containing gas, oxygen-containing gas and mixtures thereof into an elongated conduit to form a gas mixture;
(b) aligning the flow of the gas mixture using a flow straightener to form a ternary gas mixture, wherein the flow straightener comprises one or more radial plates mounted to a center body, wherein the one or more radial plates extend lengthwise in the elongated conduit, and wherein the center body tapers outwardly from an upstream point to a downstream base; and
(c) contacting the ternary gas mixture with a catalyst in a catalyst bed to provide a reaction product comprising hydrogen cyanide.

17. The process of claim 16, wherein the ternary gas mixture maintains a bed temperature variation from 15° C. to 25° C. across the catalyst bed.

18. The process of claim 16, further comprising maintaining a substantially uniform velocity profile across the flow straightener.

19. The process of claim 16, wherein the ternary gas mixture comprises at least 25 vol. % oxygen.

20. The process of claim 16, wherein the methane-containing gas, the ammonia-containing gas, and the oxygen-containing gas are mixed in the elongated conduit, wherein the pressure drop during mixing is less than 35 kPa.

21. The process of claim 20, wherein the mixing is achieved by a plurality of static mixer elements.

22. The process of claim 16, wherein the ternary gas mixture has a coefficient of variation of less than 0.1 across the diameter of the catalyst bed.

23. The process of claim 16, wherein the ternary gas mixture is substantially free of rotation.

24. The process of claim 16, wherein the center body is a pyramid.

25. The process of claim 16, wherein the downstream base of the center body is a circle, triangle, square, diamond, rectangle, pentagon, or hexagon.

26. The process of claim 16, wherein the center body is concentrically located within the elongated conduit.

27. A process for producing hydrogen cyanide, comprising:
(a) aligning the flow of methane-containing gas and an ammonia-containing gas introduced into an elongated conduit and mixing to form a binary mixture;
(b) aligning the flow of the binary mixture and an oxygen-maintaining gas into the elongated conduit and mixing to form a ternary gas mixture; and
(c) contacting the ternary gas mixture with a catalyst in a catalyst bed to provide a reaction product comprising hydrogen cyanide,
wherein the flow straightener comprises one or more radial plates mounted to a center body, wherein the one or more radial plates extend lengthwise in the elongated conduit, and wherein the center body tapers outwardly from an upstream point to a downstream base.

28. The process of claim 27, wherein the ternary gas mixture maintains a bed temperature variation from 15° C. to 25° C. across the catalyst bed.

29. The process of claim 27, further comprising maintaining a substantially uniform velocity profile across the flow straightener.

30. The process of claim 27, wherein the pressure drop during mixing is less than 35 kPa.

31. The process of claim 27, wherein the ternary gas mixture has a coefficient of variation of less than 0.1 across the diameter of the catalyst bed.

32. A reaction assembly for preparing hydrogen cyanide comprising:
(a) a mixing vessel to produce a ternary gas mixture comprising an elongated conduit which includes:
i. an outlet located at a downstream end of the elongated conduit;
ii. an internal wall;
iii. a first static mixing zone comprising a first inlet port for introducing at least one reactant gas selected from the group consisting of a methane-containing gas, an ammonia-containing gas, an oxygen-containing gas, and mixtures thereof, into the mixing vessel and a first flow straightener positioned downstream of the first inlet; and
iv. a second static mixing zone located downstream to the first static mixing zone and comprising a second inlet port for introducing an oxygen-containing gas, and a second flow straightener positioned downstream of the second inlet;
wherein the second flow straightener comprises one or more radial plates mounted to a center body, wherein the one or more radial plates extend lengthwise in the elongated conduit, and wherein the center body tapers outwardly towards the internal wall from an upstream point to a downstream base; and
(b) a reactor vessel comprising a reactor inlet that is operatively coupled to the outlet to receive the ternary gas mixture, and a catalyst bed containing a catalyst for producing a hydrogen cyanide stream.

33. The reaction assembly of claim 32, wherein the flow straightener comprises from one to ten radial plates.

34. The reaction assembly of claim 32, wherein the flow straightener has a unibody assembly.

35. The reaction assembly of claim 32, wherein the first flow straightener comprises one or more radial plates mounted to a center body, wherein the one or more radial plates extend lengthwise in the elongated conduit, and wherein the center body tapers outwardly towards the internal wall from an upstream point to a downstream base.
